(19) United States
(12) Patent Application Publication
(10) Pub. No.: US 2019/0140309 A1
(43) Pub. Date: May 9, 2019

(54) ELECTROLYTE SOLUTIONS AND ELECTROCHEMICAL CELLS CONTAINING SAME

(71) Applicant: 3M INNOVATIVE PROPERTIES COMPANY, St. Paul, MN (US)

(72) Inventors: William M. Lamanna, Stillwater, MN (US); Kiah A. Smith, Mahtomedi, MN (US); Ang Xiao, Woodbury, MN (US)

(21) Appl. No.: 16/309,973

(22) PCT Filed: Jun. 14, 2017
(86) PCT No.: PCT/US17/37369

§ 371 Date: Dec. 14, 2018

Related U.S. Application Data
(60) Provisional application No. 62/351,575, filed on Jun. 17, 2016.

(51) Int. Cl. H01M 10/0525; C08K 5/17; H01M 10/0567; H01M 10/0568; H01M 10/0569

(52) U.S. Cl. CPC H01M 10/0525; C08K 5/17; H01M 10/0569; H01M 10/0568; H01M 10/0567

(57) ABSTRACT

In some embodiments, an electrolyte solution includes a solvent; an electrolyte salt; and a salt represented by the following general formula (I): [HxL]^{x+}[FnA⁻]x where: A is boron or phosphorous, F is fluorine, H is an acidic hydrogen, L is an aprotic organic amine, n is 4 or 6, when n=4, A is boron, and when n=6, A is phosphorous, x is an integer from 1-3, and at least one N atom of the aprotic organic amine is protonated by an acidic hydrogen atom. The salt is present in the electrolyte solution in an amount of between 0.1 and 5 wt. %, based on the total weight of the electrolyte solution.

### FIELD

The present disclosure relates to electrolyte solutions for electrochemical cells.

### BACKGROUND

Various electrolyte compositions have been introduced for use in electrochemical cells. Such compositions are described, for example, in JP 2013/097908; U.S. Pat. Pub. 2011/021489; U.S. Pat. Pub. 2012/0021279; JP 2010/044883; and JP 2009/218005.

### SUMMARY

In some embodiments, an electrolyte solution is provided. The electrolyte solution includes a solvent; an electrolyte salt; and a salt represented by the following general formula I:

[HxL]^{x+}[FnA⁻]x (I)

where: A is boron or phosphorous, F is fluorine, H is an acidic hydrogen, L is an aprotic organic amine, n is 4 or 6, when n=4, A is boron, and when n=6, A is phosphorous, x is an integer from 1-3, and at least one N atom of the aprotic organic amine is protonated by an acidic hydrogen atom. The salt is present in the electrolyte solution in an amount of between 0.1 and 5 wt. %, based on the total weight of the electrolyte solution. The mole ratio of the salt to a Lewis acid-Lewis base complex having the formula [(FmA)x′-L] in the electrolyte solution is greater than 10, where: x′ is an integer from 1-3, m is 3 or 5, when m=3, A is boron, and when m=5, A is phosphorous.

In some embodiments, an electrochemical cell is provided. The electrochemical cell includes a positive electrode; a negative electrode; and an electrolyte solution. The electrolyte solution includes a solvent; an electrolyte salt; and a salt represented by the following general formula I:

[HxL]^{x+}[FnA⁻]x (I)

where: A is boron or phosphorous, F is fluorine, H is an acidic hydrogen, L is an aprotic organic amine, n is 4 or 6, when n=4, A is boron, and when n=6, A is phosphorous, x is an integer from 1-3, and at least one N atom of the aprotic organic amine is protonated by an acidic hydrogen atom. Prior to incorporation into the electrochemical cell, the salt is present in the electrolyte solution in an amount of between 0.1 and 5 wt. %, based on the total weight of the electrolyte solution, and the mole ratio of the salt to a Lewis acid-Lewis base complex having the formula [(FmA)x′-L] in the electrolyte solution is greater than 10, where: x′ is an integer from 1-3, m is 3 or 5, when m=3, A is boron, and when m=5, A is phosphorous.

In some embodiments, a method of making an electrolyte solution is provided. The method includes combining a solvent, an electrolyte salt, and a salt represented by the following general formula I:

[HxL]^{x+}[FnA⁻]x (I)

where: A is boron or phosphorous, F is fluorine, H is an acidic hydrogen, L is an aprotic organic amine, n is 4 or 6, when n=4, A is boron, and when n=6, A is phosphorous, x is an integer from 1-3, and at least one N atom of the aprotic organic amine is protonated by an acidic hydrogen atom. The salt is present in the electrolyte solution in an amount of between 0.1 and 5 wt. %, based on the total weight of the electrolyte solution. The mole ratio of the salt to a Lewis acid-Lewis base complex having the formula [(FmA)x′-L] in the electrolyte solution is greater than 10, where: x′ is an integer from 1-3, m is 3 or 5, when m=3, A is boron, and when m=5, A is phosphorous.

In some embodiments, a method of forming an electrochemical cell is provided. The method includes providing a positive electrode; providing a negative electrode; and providing an electrolyte solution. The electrolyte solution includes a solvent; an electrolyte salt; and a salt represented by the following general formula I:

[HxL]^{x+}[FnA⁻]x (I)

where: A is boron or phosphorous, F is fluorine, H is an acidic hydrogen atom, L is an aprotic organic amine, n is 4 or 6, when n=4, A is boron, and when n=6, A is phosphorous, x is an integer from 1-3, and at least one N atom of the aprotic organic amine is protonated by an acidic hydrogen atom. Prior to incorporation into the electrochemical cell, (i) the salt is present in the electrolyte solution in an amount of between 0.1 and 5 wt. %, based on the total weight of the electrolyte solution, and (ii) the mole ratio of the salt to a Lewis acid-Lewis base complex having the formula [(FmA)x′-L] in the electrolyte solution is greater than 10, where: x′ is an integer from 1-3, m is 3 or 5, when m=3, A is boron, and when m=5, A is phosphorous. The method further includes incorporating the positive electrode, negative electrode, and electrolyte into a cell to form an electrochemical cell.

The above summary is not intended to describe each disclosed embodiment of every implementation of the present disclosure. The brief description of the drawings and the detailed description which follows more particularly exemplify illustrative embodiments.

### BRIEF DESCRIPTION OF THE DRAWINGS

FIG. 1 is a plot of capacity retention v. cycle number for electrochemical cells that include electrolyte solutions according to some embodiments of the present disclosure and electrochemical cells that include comparative electrolyte solutions.

### DETAILED DESCRIPTION

The most extensively used lithium-ion battery electrolytes have limited thermal and high voltage stability. Thermal and electrochemical degradation of the electrolyte is considered a primary cause of reduced lithium-ion battery performance over time. Many of the performance and safety issues associated with advanced lithium-ion batteries are the direct or indirect result of undesired reactions that occur between the electrolyte and the highly reactive positive or negative electrodes. Such reactions result in reduced cycle life, capacity fade, gas generation (which can result in cell swelling or venting), impedance growth, and reduced rate capability. Typically, driving the electrodes to greater voltage extremes or exposing the cell to higher temperatures accelerates these undesired reactions and magnifies the associated problems. Under extreme abuse conditions, uncontrolled reaction exotherms may result in thermal runaway and catastrophic disintegration of the cell.

Stabilizing the electrode/electrolyte interface is an important factor in controlling and minimizing these undesirable reactions and improving the cycle life and voltage and temperature performance limits of lithium-ion batteries. Electrolyte additives designed to selectively react with, bond to, or self-organize at the electrode surface in a way that passivates the interface represents one of the simplest and potentially most cost effective ways of achieving this goal. The effect of common electrolyte solvents and additives, such as ethylene carbonate (EC), vinylene carbonate (VC), 2-fluoroethylene carbonate (FEC), and lithium bisoxalatoborate (LiBOB), on the stability of the negative electrode SEI (solid-electrolyte interface) layer is well documented.

However, there is an ongoing need for electrolyte additives that are capable of further improving the high temperature performance and stability (e.g. >55° C.) of lithium ion cells, provide electrolyte stability at high voltages (e.g. >4.2V) for increased energy density, and enable the use of high voltage electrodes.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

As used herein, “aprotic organic amine” means an organic compound that includes nitrogen, and in which there are no hydrogen atoms directly bound to nitrogen or directly bound to other heteroatoms (such as O and S) that may optionally be present in the compound in its neutrally charged state.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Generally, the present disclosure, in some embodiments, relates to a class of salts that can act as performance enhancing additives to the electrolytes of electrochemical cells (e.g., lithium ion electrochemical cells). These salts can provide performance benefits in electrochemical cells when used at relatively low loadings in the electrolyte (e.g., <5 wt % of the total electrolyte solution). For example, electrochemical cells having electrolytes that include the salts of the present disclosure, relative to known electrolytes including known additives, may exhibit improved high temperature storage performance, improved coulombic efficiency, improved charge endpoint capacity slippage, less impedance growth, reduced gas generation and improved charge-discharge cycling. Furthermore, the salts of the present disclosure display air and moisture stability, thus providing improved ease of handling and improved safety vs. known additives (e.g., BF3-pyridine, BF3-diethyl ether and BF3-dimethyl carbonate, some of which rapidly hydrolyze in air to produce a visible white smoke). Still further, the unexpected efficacy of the present salts at low loadings can lead to a reduction in overall electrolyte additive cost per electrochemical cell. Indeed, reduction in material costs is an important factor in the adoption of lithium-ion battery technology in new applications (e.g., electric vehicles, renewable energy storage).

In some embodiments, the present disclosure relates to electrolyte solutions for electrochemical cells. The electrolyte solutions may include a solvent, one or more electrolyte salts, and one or more salts having formula I, as shown below.

In various embodiments, the electrolyte solutions may include one or more solvents. In some embodiments, the solvent may include one or more organic carbonates. Examples of suitable solvents include ethylene carbonate, diethyl carbonate, dimethyl carbonate, ethyl methyl carbonate, vinylene carbonate, propylene carbonate, fluoroethylene carbonate, tetrahydrofuran (THF), acetonitrile, gamma butyrolactone, sulfolane, ethyl acetate, or combinations thereof. In some embodiments, organic polymer containing electrolyte solvents, which can include solid polymer electrolytes or gel polymer electrolytes, may also be employed. Organic polymers may include polyethylene oxide, polypropylene oxide, ethylene oxide/propylene oxide copolymers, polyacrylonitrile, polyvinylidene fluoride, vinylidene fluoride-hexafluoropropylene copolymers, and poly-[bis((methoxyethoxy)ethoxy)phosphazene] (MEEP), or combinations thereof. The solvents may be present in the electrolyte solution in an amount of between 15 and 98 wt. %, 25 and 95 wt. %, 50 and 90 wt. %, or 70 and 90 wt. %, based on the total weight of the electrolyte solution.

In some embodiments, the electrolyte solution may include one or more electrolyte salts. In some embodiments, the electrolyte salts may include lithium salts and, optionally, other salts such as sodium salts (e.g., NaPF6). Suitable lithium salts may include LiPF6, LiBF4, LiClO4, lithium bis(oxalato)borate, LiN(SO2CF3)2, LiN(SO2C2F5)2, LiAsF6, LiC(SO2CF3)3, LiN(SO2F)2, LiN(SO2F)(SO2CF3), LiN(SO2F)(SO2C4F9), or combinations thereof. In some embodiments, the lithium salts may include LiPF6, lithium bis(oxalato)borate, LiN(SO2CF3)2, or combinations thereof. In some embodiments, the lithium salts may include LiPF6 and either or both of lithium bis(oxalato)borate and LiN(SO2CF3)2. The electrolyte salts may be present in the electrolyte solution in an amount of between 2 and 85 wt %, 5 and 75 wt %, 10 and 50 wt %, or 10 and 30 wt %, based on the total weight of the electrolyte solution.

In some embodiments, the electrolyte solutions may include one or more salts having the following formula (I):

[HxL]^{x+}[FnA⁻]x (I)

where:

A is boron or phosphorous,

F is fluorine,

H is an acidic hydrogen atom,

L is an aprotic organic amine,

n is 4 or 6,

when n=4, A is boron, and when n=6, A is phosphorous, and

x is an integer from 1-3 or 1-2.

In some embodiments, at least one nitrogen atom (or up to two or up to three nitrogen atoms) of the aprotic organic amine of formula I may be protonated by an acidic hydrogen atom.

Salts having formula (I) may be prepared by reaction of an aprotic organic amine, L, with x moles of a Bronsted acid, HAFn, where x, n, and A are as defined above. In some embodiments, the salt having formula (I) may be a stoichiometric salt (i.e., very little, if any, excess Bonsted acid or free aprotic organic amine (base) may be present in the electrolyte). For example, excess acid or base may be present in the electrolyte solution at less than 10 mol %, less than 5 mol %, less than 3 mol %, or less than 1 mol %, based on the stoichiometry indicated in the salt structural formula(s).

In some embodiments, the aprotic organic amine (L) in formula (I) is a neutral amine that may include at least one N atom with a non-bonding electron pair that is available for bonding with an acidic hydrogen atom from the Bronsted acid (HAFn). In illustrative embodiments, the aprotic organic amines may include tertiary amines that may be cyclic or acyclic, saturated or unsaturated, substituted or unsubstituted, and may optionally contain other catenary heteroatoms, such as O, S, and N, in the carbon chain or ring. In some embodiments, the aprotic organic amines may include heteroaromatic amines that may be substituted or unsubstituted and may optionally contain other catenary heteroatoms, such as O, S, and N, in the carbon chain or ring.

In some embodiments, suitable tertiary amines may include trimethylamine, triethylamine, tributylamine, tripentylamine, trihexylamine, trioctylamine, N,N-diisopropylethylamine, benzyldimethylamine, triphenylamine, N,N-diethylmethylamine, N-methylpiperidine, N-ethylpiperidine, 1-chloro-N,N-dimethyl-methanamine, N-ethyl-N-(methoxymethyl)-ethanamine, N-methylpyrrolidine, N-ethylpyrrolidine, N-propylpyrrolidine, N-butyllpyrrolidine, 1,8-diazabicycloundec-7-ene, 1,5-diazabicyclo[4.3.0]non-5-ene, 7-methyl-1,5,7-triazabicyclo[4.4.0]dec-5-ene, 1,4-diazabicyclo-[2.2.2]-octane, 1-azabicyclo[2.2.2]-octane, N,N,N′,N′-tetramethyl-1,4-butanediamine, N,N,N′,N′-tetramethyl-2-butene-1,4-diamine, N,N,N′,N′,N″-pentamethyldiethylenetriamine, 1,3,5-trimethylhexahydro-1,3,5-triazine, 2-isopropyliminopropane, 4-methylmorpholine, 1-[(methylthio)methyl]-piperidine.

In some embodiments, suitable heteroaromatic amines may include pyridine, pyrazine, pyridazine, pyrimidine, 4-dimethylaminopyridine, 1-methylimidizole, 1-methylpyrazole, thiazole, oxazole, all isomers thereof and substituted variants thereof wherein the substituent groups can include either H; F; nitrile groups; separate alkyl or fluoroalkyl groups from 1 to 4 carbon atoms, respectively or joined together to constitute a unitary alkylene radical of 2 to 4 carbon atoms forming a ring structure; alkoxy or fluoroalkoxy groups; or separate aryl or fluoroaryl groups.

In some embodiments, the salts of formula I may be selected from:

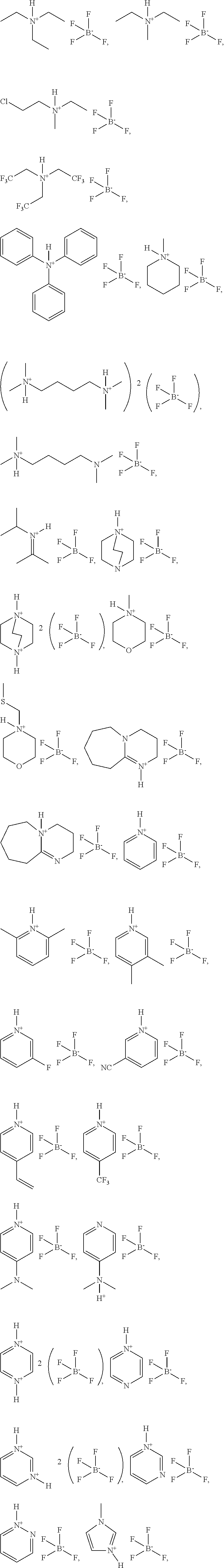

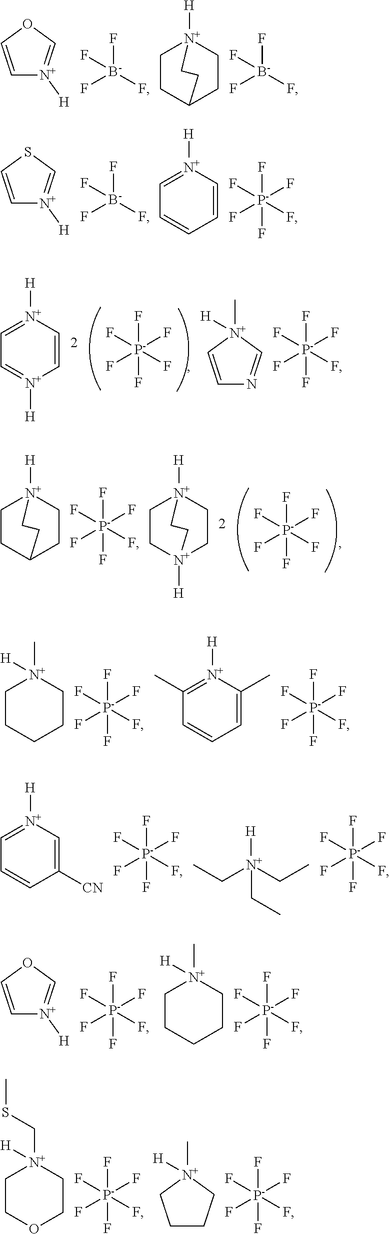

or combinations thereof

In some embodiments, the salts of formula I may be present in the electrolyte solution in an amount of between 0.01 and 40.0 wt. %, 0.01 and 20.0 wt. %, 0.01 and 10.0 wt. %, 0.01 and 5.0 wt. %, 0.1 and 5.0 wt. %, or 0.2 and 5.0 wt. % based on the total weight of the electrolyte solution.

For purposes of the present application, the electrolyte solutions may be described at a point in time prior to incorporation of the same into an electrochemical cell. That is, the materials described herein may be distinguished from those materials that have previously been exposed to water contained in the electrochemical cell or subjected to one or more charge/discharge cycles in an electrochemical cell.

In some embodiments, the electrolyte solutions may further include a Lewis acid-Lewis Base (LA:LB) complex, such as those LA:LB complexes of formula II:

[(FmA)x′-L] (II)

where, in addition to the definitions provided above,

x′ is an integer from 1-3

m is 3 or 5,

when m=3, A is boron, and when m=5, A is phosphorous.

In embodiments in which such LA:LB complexes are present in the electrolyte solution, the mole ratio of the salt of formula I to the LA:LB complex of formula (II) in the electrolyte solution may be greater than 10, greater than 20, greater than 50, greater than 75, or greater than 100.

In some embodiments, the electrolyte solutions of the present disclosure may also include one or more conventional electrolyte additives such as, for example, vinylene carbonate (VC), fluoroethylene carbonate (FEC), propane-1,3-sultone (PS), prop-1-ene-1,3-sultone (PES), succinonitrile (SN), 1,5,2,4-dioxadithiane-2,2,4,4-tetraoxide (MMDS), lithium bis(oxalate)borate (LiBOB), lithium difluoro(oxalato)borate (LiDFOB), tris(trimethylsilyl)phosphite (TTSPi), ethylene sulfite (ES), 1,3,2-dioxathiolan-2,2-oxide (DTD), vinyl ethylene carbonate (VEC), trimethylene sulfite (TMS), tri-allyl-phosphate (TAP), methyl phenyl carbonate (MPC), diphenyl carbonate (DPC), ethyl phenyl carbonate (EPC), and tris(trimethylsilyl)phosphate (TTSP).

In some embodiments, the present disclosure is further directed to electrochemical cells that include the above-described electrolyte solutions. In addition to the electrolyte solution, the electrochemical cells may include at least one positive electrode, at least one negative electrode, and a separator.

In some embodiments, the positive electrode may include a current collector having disposed thereon a positive electrode composition. The current collector for the positive electrode may be formed of a conductive material such as a metal. According to some embodiments, the current collector includes aluminum or an aluminum alloy. According to some embodiments, the thickness of the current collector is 5 μm to 75 μm. It should also be noted that while the positive current collector may be described as being a thin foil material, the positive current collector may have any of a variety of other configurations according to various exemplary embodiments. For example, the positive current collector may be a grid such as a mesh grid, an expanded metal grid, a photochemically etched grid, or the like.

In some embodiments, the positive electrode composition may include an active material. The active material may include a lithium metal oxide or lithium metal phosphate. In an exemplary embodiment, the active material may include lithium transition metal oxide intercalation compounds such as LiCoO2, LiCo0.2Ni0.8O2, LiMn2O4, LiFePO4, LiNiO2, or lithium mixed metal oxides of manganese, nickel, and cobalt in any proportion. Blends of these materials can also be used in positive electrode compositions. Other exemplary cathode materials are disclosed in U.S. Pat. No. 6,680,145 (Obrovac et al.) and include transition metal grains in combination with lithium-containing grains.

Suitable transition metal grains include, for example, iron, cobalt, chromium, nickel, vanadium, manganese, copper, zinc, zirconium, molybdenum, niobium, or combinations thereof with a grain size no greater than about 50 nanometers. Suitable lithium-containing grains can be selected from lithium oxides, lithium sulfides, lithium halides (e.g., chlorides, bromides, iodides, or fluorides), or combinations thereof. The positive electrode composition may further include additives such as binders (e.g., polymeric binders (e.g., polyvinylidene fluoride)), conductive diluents (e.g., carbon), fillers, adhesion promoters, thickening agents for coating viscosity modification such as carboxymethylcellulose, or other additives known by those skilled in the art.

The positive electrode composition can be provided on only one side of the positive current collector or it may be provided or coated on both sides of the current collector. The thickness of the positive electrode composition may be 0.1 μm to 3 mm, 10 μm to 300 or 20 μm to 90 μm.

In various embodiments, the negative electrode may include a current collector and a negative electrode composition disposed on the current collector. The current collector of the negative electrode may be formed of a conductive material such as a metal. According to some embodiments, the current collector includes copper or a copper alloy, titanium or a titanium alloy, nickel or a nickel alloy, or aluminum or an aluminum alloy. According to some embodiments, the thickness of the current collector may be 5 μm to 75 μm. It should also be noted that while the current collector of the negative electrode may be described as being a thin foil material, the current collector may have any of a variety of other configurations according to various exemplary embodiments. For example, the current collector of the negative electrode may be a grid such as a mesh grid, an expanded metal grid, a photochemically etched grid, or the like.

In some embodiments, the negative electrode composition may include an active material (e.g., a material that is capable of intercalating or alloying with lithium.) The active material may include lithium metal, carbonaceous materials, or metal alloys (e.g., silicon alloy composition or lithium alloy compositions). Suitable carbonaceous materials can include synthetic graphites such as mesocarbon microbeads (MCMB) (available from China Steel, Taiwan, China), SLP30 (available from TimCal Ltd., Bodio Switzerland), natural graphites and hard carbons. Suitable alloys may include electrochemically active components such as silicon, tin, aluminum, gallium, indium, lead, bismuth, and zinc and may also include electrochemically inactive components such as iron, cobalt, transition metal silicides and transition metal aluminides. In some embodiments, the active material of the negative electrode includes a silicon alloy.

In some embodiments, the negative electrode composition may further include additives such as binders (e.g., polymeric binders (e.g., polyvinylidene fluoride or styrene butadiene rubber (SBR)), conductive diluents (e.g., carbon black and/or carbon nanotubes), fillers, adhesion promoters, thickening agents for coating viscosity modification such as carboxymethylcellulose, or other additives known by those skilled in the art.

In various embodiments, the negative electrode composition can be provided on only one side of the negative current collector or it may be provided or coated on both sides of the current collector. The thickness of the negative electrode composition may be 0.1 μm to 3 mm, 10 μm to 300 μm, or 20 μm to 90 μm.

In some embodiments, the electrochemical cells of the present disclosure may include a separator (e.g., a polymeric microporous separator which may or may not be coated with a layer of inorganic particles such as Al₂O₃) provided intermediate or between the positive electrode and the negative electrode. The electrodes may be provided as relatively flat or planar plates or may be wrapped or wound in a spiral or other configuration (e.g., an oval configuration). For example, the electrodes may be wrapped around a relatively rectangular mandrel such that they form an oval wound coil for insertion into a relatively prismatic battery case. According to other exemplary embodiments, the battery may be provided as a button cell battery, a thin film solid state battery, or as another lithium ion battery configuration.

According to some embodiments, the separator can be a polymeric material such as a polypropylene/polyethylene copolymer or another polyolefin multilayer laminate that includes micropores formed therein to allow electrolyte and lithium ions to flow from one side of the separator to the other. The thickness of the separator may be between approximately 10 micrometers (μm) and 50 μm according to an exemplary embodiment. The average pore size of the separator may be between approximately 0.02 μm and 0.1 μm.

In some embodiments, the present disclosure is further directed to electronic devices that include the above-described electrochemical cells. For example, the disclosed electrochemical cells can be used in a variety of devices including, without limitation, portable computers, tablet displays, personal digital assistants, mobile telephones, motorized devices (e.g., personal or household appliances and vehicles), power tools, illumination devices, and heating devices.

In some embodiments, the present disclosure relates to methods of making the salts of formula (I). The methods may include titrating a stoichiometric amount of a neutral, aprotic, organic amine, L, into a solution of a Bronsted acid of the formula HAFn. The resulting product salt of formula (I) may then be isolated using conventional techniques prior to formulation into a battery electrolyte.

The present disclosure further relates to methods of making the above-described electrolyte solutions. The method may include combining one or more of the above-described solvent(s), one or more of the above-described electrolyte salts, and one or more of the above described salts having formula (I). The method may further include combining these components in the relative amounts discussed above.

The present disclosure further relates to methods of making an electrochemical cell. In various embodiments, the method may include providing the above-described negative electrode, providing the above-described positive electrode, and incorporating the negative electrode and the positive electrode into a battery comprising the above-described electrolyte solution.

### Listing of Embodiments

1. An electrolyte solution comprising:
a solvent;
an electrolyte salt; and
a salt represented by the following general formula I:

[HₓL]^{x+}[FₙA⁻]ₓ (I)
where:
   A is boron or phosphorous,
   F is fluorine,
   H is acidic hydrogen
   L is an aprotic organic amine,
   n is 4 or 6,
   when n=4, A is boron, and when n=6, A is phosphorous,
   x is an integer from 1-3, and
   at least one N atom of the aprotic organic amine is protonated by an acidic hydrogen atom,
   wherein the salt is present in the electrolyte solution in an amount of between 0.1 and 5 wt. %, based on the total weight of the electrolyte solution, and
   wherein the mole ratio of the salt to a Lewis acid-Lewis base complex having the formula [(FmA)x′-L] in the electrolyte solution is greater than 10,
where:
x′ is an integer from 1-3,
m is 3 or 5,
when m=3, A is boron, and when m=5, A is phosphorous.
   2. The electrolyte solution of embodiment 1, wherein the aprotic organic amine is a neutral amine that comprises at least one nitrogen atom with a non-bonding electron pair that is available for protonation by a Bronsted acid.
   3. The electrolyte solution according to any one of the previous embodiments, wherein the aprotic organic amine comprises a tertiary amine.
   4. The electrolyte solution according to any one of the previous embodiments, wherein the aprotic organic amine comprises a heteroaromatic amine.
   5. The electrolyte solution according to any one of the previous embodiments, wherein the solvent comprises an organic carbonate.
   6. The electrolyte solution according to any one of the previous embodiments, wherein the solvent comprises ethylene carbonate, diethyl carbonate, dimethyl carbonate, ethyl methyl carbonate, vinylene carbonate, propylene carbonate, fluoroethylene carbonate, tetrahydrofuran (THF), gamma butyrolactone, sulfolane, ethyl acetate, or acetonitrile.
   7. The electrolyte solution according to any one of the previous embodiments, wherein the solvent is present in the solution in an amount of between 15 and 98 wt. %, based on the total weight of the electrolyte solution.
   8. The electrolyte solution according to any one of the previous embodiments, wherein the electrolyte salt comprises a lithium salt.
   9. The electrolyte solution according to any one of the previous embodiments, wherein the electrolyte salt comprises LiPF6, LiBF4, LiClO4, lithium bis(oxalato)borate, LiN(SO2CF3)2, LiN(SO2C2F5)2, LiAsF6, LiC(SO2CF3)3, LiN(SO2F)2, LiN(SO2F)(SO2CF3), or LiN(SO2F)(SO2C4F9).
   10. The electrolyte solution according to any one of the previous embodiments, wherein the electrolyte salt is present in the solution in an amount of between 5 and 75 wt. %, based on the total weight of the electrolyte solution.
   11. An electrochemical cell comprising:
a positive electrode;
a negative electrode; and
an electrolyte solution comprising:
   a solvent;
   an electrolyte salt; and
      a salt represented by the following
      general formula I:

[HxL]^{x+}[FnA⁻]x (I)
where: A is boron or phosphorous,
F is fluorine,
H is an acidic hydrogen atom
L is an aprotic organic amine,
n is 4 or 6,
when n=4, A is boron, and when n=6, A is phosphorous,
x is an integer from 1-3, and
at least one N atom of the aprotic organic amine is protonated by an acidic hydrogen atom,
wherein prior to incorporation into the electrochemical cell, (i) the salt is present in the electrolyte solution in an amount of between 0.1 and 5 wt. %, based on the total weight of the electrolyte solution, and (ii) the mole ratio of the salt to a Lewis acid-Lewis base complex having the formula [(FmA)x′-L] in the electrolyte solution is greater than 10.
where:
x′ is an integer from 1-3
m is 3 or 5,
when m=3, A is boron, and when m=5, A is phosphorous.
   12. The electrochemical cell of embodiment 11, wherein the aprotic organic amine is a neutral amine that comprises at least one nitrogen atom with a non-bonding electron pair that is available for protonation by a Bronsted acid.
   13. The electrochemical cell according to any one embodiments 11-12, wherein the aprotic organic amine comprises a tertiary amine.
   14. The electrochemical cell according to any one embodiments 11-13, wherein the aprotic organic amine comprises a heteroaromatic amine.
   15. The electrochemical cell according to any one embodiments 11-14, wherein excess Bronsted acid or free aprotic organic amine (base) is present in the electrolyte solution at less than 5 mol % based on the stoichiometry of general formula I.
   16. The electrochemical cell according to any one embodiments 11-15, wherein the solvent comprises an organic carbonate.
   17. The electrochemical cell according to any one embodiments 11-16, wherein the solvent comprises ethylene carbonate, diethyl carbonate, dimethyl carbonate, ethyl methyl carbonate, vinylene carbonate, propylene carbonate, fluoroethylene carbonate, tetrahydrofuran (THF), gamma butyrolactone, sulfolane, ethyl acetate, or acetonitrile.
   18. The electrochemical cell according to any one embodiments 11-17, wherein the solvent is present in the solution in an amount of between 15 and 98 wt. %, based on the total weight of the electrolyte solution.
   19. The electrochemical cell according to any one embodiments 11-18, wherein the electrolyte salt comprises a lithium salt.
   20. The electrochemical cell according to any one embodiments 11-19, wherein the electrolyte salt comprises LiPF6, LiBF4, LiClO4, lithium bis(oxalato)borate, LiN(SO2CF3)2, LiN(SO2C2F5)2, LiAsF6, LiC(SO2CF3)3, LiN(SO2F)2, LiN(SO2F)(SO2CF3), or LiN(SO2F)(SO2C4F9).
   21. The electrochemical cell according to any one embodiments 11-20, wherein the electrolyte salt is present in the solution in an amount of between 5 and 75 wt. %, based on the total weight of the electrolyte solution.
   22. An electrochemical cell comprising:

a positive electrode;

a negative electrode; and

an electrolyte solution according to any one of embodiments 1-10.

23. The electrochemical cell according to embodiment 22, wherein the positive electrode comprises an active material, the active material comprising a lithium metal oxide or a lithium metal phosphate.
24. The electrochemical cell according to any one of embodiments 22-23, wherein the negative electrode comprises an active material, the active material comprising lithium metal, a carbonaceous material, or a metal alloy.
25. A method of making an electrolyte solution, the method comprising:
combining a solvent, an electrolyte salt, and a salt represented by the following general formula:
a salt represented by the following general formula I:

[HxL]^{x+}[FnA⁻]x (I)
where:
A is boron or phosphorous,
F is fluorine,
H is an acidic hydrogen atom
L is an aprotic organic amine,
n is 4 or 6,
when n=4, A is boron, and when n=6, A is phosphorous,
x is an integer from 1-3, and
at least one N atom of the aprotic organic amine is protonated by an acidic hydrogen atom,
wherein (i) the salt is present in the electrolyte solution in an amount of between 0.1 and 5 wt. %, based on the total weight of the electrolyte solution, and (ii) the mole ratio of the salt to a Lewis acid-Lewis base complex having the formula [(FmA)x′-L] in the electrolyte solution is greater than 10.
where:
x′ is an integer from 1-3,
m is 3 or 5,
   when m=3, A is boron, and when m=5, A is phosphorous.
   26. A method of forming an electrochemical cell comprising:
providing a positive electrode;
providing a negative electrode; and
providing an electrolyte solution comprising:
   a solvent;
   an electrolyte salt; and
      a salt represented by the following general formula I:

[HxL]^{x+}[FnA⁻]x (I)
where:
A is boron or phosphorous,
F is fluorine,
H is an acidic hydrogen atom
L is an aprotic organic amine,
n is 4 or 6,
when n=4, A is boron, and when n=6, A is phosphorous,
x is an integer from 1-3, and
at least one N atom of the aprotic organic amine is protonated by an acidic hydrogen atom,
wherein prior to incorporation into the electrochemical cell, (i) the salt is present in the electrolyte solution in an amount of between 0.1 and 5 wt. %, based on the total weight of the electrolyte solution, and (ii) the mole ratio of the salt to a Lewis acid-Lewis base complex having the formula [(FmA)x′-L] in the electrolyte solution is greater than 10.
where:
x′ is an integer from 1-3,
m is 3 or 5,
when m=3, A is boron, and when m=5, A is phosphorous; and
incorporating the positive electrode, negative electrode, and electrolyte into a cell to form an electrochemical cell.

### Examples

Objects and advantages of this disclosure are further illustrated by the following illustrative examples.

| Name | Description | Source |
|---|---|---|
| Ethylene Carbonate (EC) | 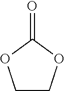 | BASF, USA |
| Ethyl Methyl Carbonate (EMC) | 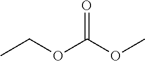 | BASF, USA |
| Dimethyl Carbonate (DMC) | 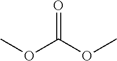 | BASF, USA |
| Lithium | LiPF6 | BASF, USA |
| hexafluorophosphate | | |
| NMC111 | LiNi0.33Mn0.33Co0.33O2 | Umicore, |
| | | Korea |
| NMC442 | LiNi0.42Mn0.42Co0.16O2 | Umicore, |
| | | Korea |
| Lithium Cobalt Oxide | LiCoO2 | Umicore, |
| (LCO) | | Korea |
| Conductive Carbon | Super P | Timcal |
| | | graphite and |
| | | carbon, |
| | | Switzerland |
| PVDF | Polyvinylidene Fluoride | Arkema, USA |
| MCMB | Meso Carbon Micro Bead | China Steel, |
| | | Taiwan |
| N-Methyl-2-Pyrrolidone (NMP) | 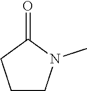 | Honeywell, USA |
| Triallylphosphate (TAP) | O═P(OCH2CH═CH2)3 | Capchem, |
| | | China |
| Tetrafluoroboric acid | HBF4 | Aldrich, USA |
| Hexafluorophosphoric | HPF6 | Synquest |
| acid | | |
| Vinylene Carbonate (VC) | 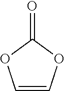 | BASF, USA |
| Prop-1-ene,1,3-sultone (PES) | 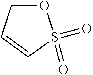 | Aldrich, USA |
| Triethylamine | 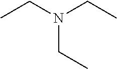 | Aldrich, USA |
| Pyridine | 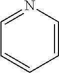 | Aldrich, USA |
| 3-Pyridine carbonitrile | 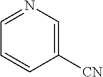 | Aldrich, USA |
| N-Methylpyridinium chloride | 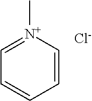 | TCI America, USA |
| Lithium bis(trifluoromethane) sulfonylimide | 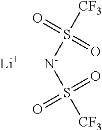 [SMILES: [Li+] ; O=S(=O)([N-]S(=O)(=O)C(F)(F)F)C(F)(F)F] | 3M, USA |
| Bis(trifluoromethane) sulfonylimide Acid | 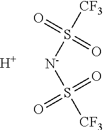 | 3M, USA |
| Pyridinium hexafluorophosphate | 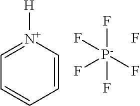 | Aldrich, USA |

### Preparation of Pyridinium Tetrafluoroborate

50% tetrafluoroboric acid aqueous solution (50.68 g, 0.289 mol) was charged to a 100 mL three neck flask. Flask was equipped with addition funnel, thermoprobe, and magnetic stirbar. Pyridine (23.97 g, 0.303 mol) was charged to addition funnel. Reaction flask contents were cooled in an ice bath. Pyridine was titrated into reaction flask slowly to moderate exotherm. Upon addition of pyridine to tetrafluoroboric acid the reaction exothermed. White solid product precipitated after a few drops of pyridine was charged. Solid continued to precipitate as pyridine was charged. Solid product is bright white. Upon complete addition of pyridine the pH of the supernatant was checked using pH strips; pH of the supernatant was roughly 7. Solid product was isolated via vacuum filtration using a water aspirator. Product was further dried in vacuum oven. The identity of the product was confirmed by ¹H and ¹⁹F NMR spectroscopy.

### Preparation of Triethylammonium Tetrafluoroborate

48% tetrafluoroboric acid aqueous solution (25.23 g, 0.138 mol) was charged to a 100 mL three neck flask. Flask was equipped with addition funnel, thermoprobe, and magnetic stirbar. Triethylamine (14.73 g, 0.146 mol) was charged to addition funnel. Reaction flask contents were cooled in an ice bath. Triethylamine was titrated into reaction flask slowly to moderate exotherm. Upon addition of triethylamine to tetrafluoroboric acid the reaction exothermed slightly. The reaction mixture remained monophasic throughout the entire addition of tetrafluoroboric acid. Excess trimethylamine and residual water were removed using a high vacuum line with a nitrogen bleed. Once most of the water and trimethylamine were remove product began to crystallize. Product was transferred to a vacuum oven to remove trace water and trimethylamine. The identity of the product was confirmed by ¹H and ¹⁹F NMR spectroscopy.

### Preparation of 3-Cyanopyridinium Tetrafluoroborate

Pyridine-3-carbonitrile (29.36 g, 0.282 mol) was dissolved in ethyl acetate (44.32 g, 0.503 mol) in a 250 mL round bottom flask. Reaction flask was equipped with addition funnel, thermoprobe, and magnetic stirbar. 50% tetrafluoroboric acid aqueous solution (49.90 g, 0.284 mol) was charged to addition funnel. Reaction flask contents were cooled in an ice bath. Tetrafluoroboric acid solution was titrated into reaction flask slowly to moderate exotherm. Upon addition of tetrafluoroboric acid to pyridine-3-carbonitrile solution the reaction exothermed slightly. Upon completion of the acid addition the reaction mixture was biphasic. Excess ethyl acetate was charged to assist in the azeotropic removal of residual water via distillation. Once most of the water and ethyl acetate were remove product began to crystallize. Product was transferred to a vacuum oven to remove trace water and ethyl acetate. The identity of the product was confirmed by ¹H and ¹⁹F NMR spectroscopy.

### Preparation of Pyridinium N,N-bis(trifluoromethylsulfonyl)imide

55% N,N-bis(trifluoromethylsulfonyl)imide acid aqueous solution (69.72 g, 0.129 mol) was charged to a 100 mL three neck flask. Flask was equipped with addition funnel, thermoprobe, and magnetic stirbar. Pyridine (10.13 g, 0.128 mol) was charged to addition funnel. Reaction flask contents were cooled in an ice bath. Pyridine was titrated into reaction flask slowly to moderate exotherm. Upon addition of pyridine to the imide acid solution the reaction exothermed. As the pyridine was charged the reaction mixture became biphasic. Upon complete addition of pyridine the pH of the aqueous phased was checked using pH strips; pH of the supernatant was roughly 7. Reaction mixture was charged to a separatory funnel were the liquid product was isolated from the aqueous phase. Following isolation the product was washed with water three additional times. Product was further dried in vacuum oven. Upon drying the product became a white solid. The identity of the product was confirmed by ¹H and ¹⁹F NMR spectroscopy.

### Preparation of N-methylpyridinium N,N-bis(trifluoromethylsulfonyl)imide

N-methylpyridinium chloride (10.016 g, 0.773 mol) was charged to a 100 mL HDPE poly bottle with magnetic stirbar. 80% lithium N,N bis(trifluoromethylsulfonyl)imide (30.45 g, 0.849 mol) aqueous solution was charged to poly bottle. Reaction mixture stirred overnight. Two layers were observed the following morning the bottom layer was observed to be a viscous liquid. Dichloromethane was charged to the organic layer dissolve organic product. Reaction mixture charged to separatory funnel. Aqueous layer removed. Organic layer was washed three times with water. After water washing the product was isolated from dichloromethane by sparging the product with nitrogen under vacuum at 60° C. The identity of the product was confirmed by ¹H and ¹⁹F NMR spectroscopy.

### Preparation of Electrolyte

1 M LiPF₆ EC/EMC (3:7 wt. % ratio, BASF) was used as the base electrolyte in the studies reported here. To this electrolyte, salt electrolyte additives were added either singly or in combination with other additives. Additive components were added at specified weight percentages in the electrolyte.

### Electrochemical Cell Preparation.

Dry Li[Ni0.42Mn0.42Co0.16]O2 (NMC442)/graphite pouch cells (240 mAh) were obtained without electrolyte from Li-Fun Technology Corporation (Xinma Industry Zone, Golden Dragon Road, Tianyuan District, Zhuzhou City, Hunan Province, PRC, 412000, China). The electrode composition in the cells was as follows: Positive electrode −96.2%:1.8%:2.0%=Active Material:Carbon Black:PVDF Binder; Negative electrode −95.4%:1.3%:1.1%:2.2%=Active material:Carbon Black:CMC:SBR. The positive electrode coating had a thickness of 105 μm and was calendared to a density of 3.55 g/cm³. The negative electrode coating had a thickness of 110 μm and was calendared to a density of 1.55 g/cm³. The positive electrode coating had an areal density of 16 mg/cm² and the negative electrode had an areal density of 9.5 mg/cm². The positive electrode dimensions were 200 mm×26 mm and the negative electrode dimensions were 204 mm×28 mm. Both electrodes were coated on both sides, except for small regions on one side at the end of the foils. All pouch cells were vacuum sealed without electrolyte in China. Before electrolyte filling, the cells were cut just below the heat seal and dried at 80° C. under vacuum for 14 h to remove any residual water. Then the cells were transferred immediately to a dry room for filling and vacuum sealing. The NMC/graphite pouch cells were filled with 0.65 g of electrolyte. After filling, cells were vacuum-sealed with a compact vacuum sealer (MSK-115A, MTI Corp.). First, cells were placed in a temperature box at 40.0±0.1° C. where they were held at 1.5 V for 24 hours, to allow for the completion of wetting. Then, cells were charged at 11 mA (C/20) to 3.8 V. After this step, cells were transferred and moved into the dry room, cut open to release gas generated and then vacuum sealed again.

### Electrochemical Storage Test Protocol

The cycling/storage procedure used in these tests is described as follows. Cells were first charged to 4.4 and discharged to 2.8 V two times. Then the cells were charged to 4.4 V at a current of C/20 (11 mA) and then held at 4.4 V until the measured current decreased to C/1000. A Maccor series 4000 cycler was used for the preparation of the cells prior to storage. After the pre-cycling process, cells were carefully moved to the storage system which monitored their open circuit voltage every 1 hours. Storage experiments were made at 60±0.1° C. for a total storage time of 480 h. Following high temperature storage cells were cycled 4 times at C/10 rate at room temperature. The voltage drop, and cell volume were measured before and after storage.

### Long Term CCCV Cycling at 4.4 V at 45° C.

Cells were formed according to description provided earlier. Cells cycled at 45° C. were put in a 45.° C.±0.5° C. temperature controlled box. Cells were connected to a Neware battery testing cycler. Cells were cycled between 2.8 and 4.4 V using a 80 mA current (equivalent to C/2.2 rate). A constant voltage charge was applied at the top of charge and maintained until the current dropped below C/20. After cycling cells were charged to 3.8 V and held at that voltage until the current dropped below C/1000.

### Measurement of Voltage Drop on Storage

The open circuit voltage of Li-ion pouch cells was measured before and after storage at either 60° C. for 480 hours. The voltage drop ((ΔV) is described in the equation 1.

ΔV=Voltage before storage−Voltage after storage eqn. 1

### Determination of Gas Evolution

Ex-situ (static) gas measurements were used to measure gas evolution during formation and during cycling. The measurements were made using Archimedes' principle with cells suspended from a balance while submerged in liquid. The changes in the weight of the cell suspended in fluid, before and after testing are directly related to the change in cell volume due to the impact on buoyant force.

The change in mass of a cell, Δm, suspended in a fluid of density, ρ, is related to the change in cell volume, Δv, by

Δv=−Δm/ρ eqn. 2

Ex-situ measurements were made by suspending pouch cells from a fine wire “hook” attached under a Shimadzu balance (AUW200D). The pouch cells were immersed in a beaker of de-ionized “nanopure” water (18.2 MΩ·cm) that was at 20±1° C. for measurement.

### Comparative Example 1-5 and Example 1-2

The additives were added to the formulated electrolyte stock solution containing 1.0M LiPF6 in EC:EMC 3:7 by wt., as described in Table 1. These electrolytes were then used in the lithium ion pouch cells containing the NMC442 cathode and artificial graphite anode.

TABLE 1
Additives added to Formulated Electrolyte Stock Solution

| | Additive and Loading |
|---|---|
| Examples | (wt % additive in formulated electrolyte) |
| Comparative | None |
| example 1 | |
| Comparative | 1.0% LiBF4 |
| example 2 | |
| Comparative | 1.0% Pyridinium bis(trifluormethylsulfonyl)imide |
| example 3 | |
| Comparative | 1.0% 1-Methyl pyridinium bis(trifluormethylsulfonyl)imide |
| example 4 | |
| Comparative | 1.0% Tributylamine bis(trifluormethylsulfonyl)imide |
| example 5 | |
| Example 1 | 1.0% Pyridinium tetrafluoroborate |
| Example 2 | 1.0% Pyridinium hexafluorophosphate |

Lithium ion pouch cells containing the NMC442 cathode and graphite anode were stored at 4.4V and at 60° C., as described above. The voltage drop, and gas evolution results are summarized in Table 2. The data clearly indicates that electrolyte containing 1.0% pyridinium tetrafluoroborate complexes of the invention as electrolyte additives reduce voltage drop, and gas generation upon storage at high temperature and high voltage.

TABLE 2
NMC442/Graphite Cell Performance Metrics
upon Storage at 60° C. and 4.4 V

| Electrolyte | Voltage drop (V) | Δ Gas volume (mL) |
|---|---|---|
| Comparative example 1 | 0.24 | 0.80 |
| Comparative example 2 | 0.20 | 0.40 |
| Comparative example 3 | 0.18 | 0.25 |
| Example 1 | 0.13 | 0.10 |
| Example 2 | 0.10 | 0.12 |

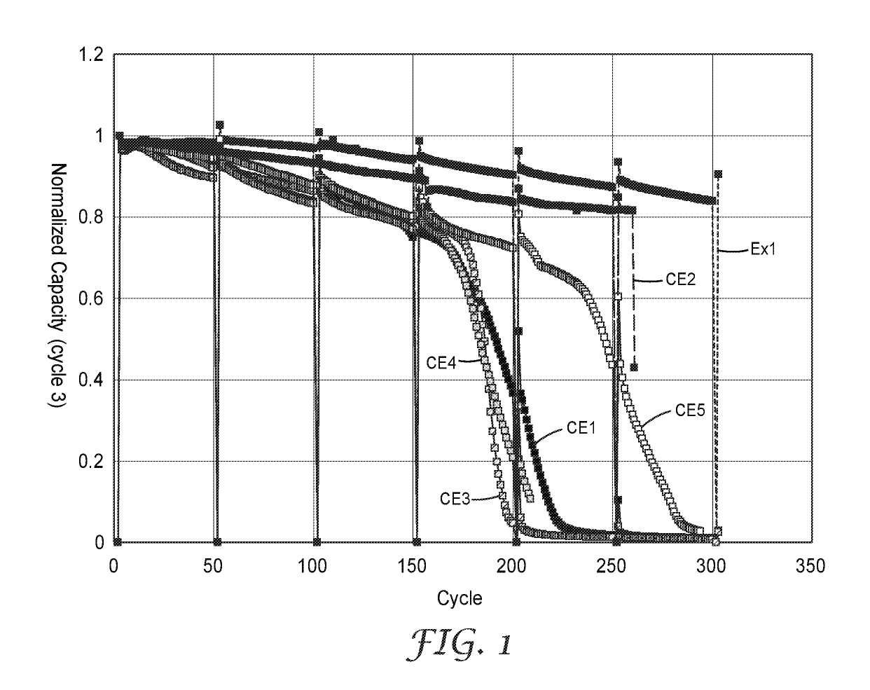

Lithium ion pouch cells containing the NMC442 cathode and graphite anode were cycled at 4.4-3.0V and at 45° C., as described above. The capacity retention VS. cycle results are showed in FIG. 1. The data clearly indicates that electrolyte containing 1.0% pyridinium tetrafluoroborate complexes of the present disclosure as electrolyte additives improve cycle life of lithium ion cells at high temperature and high voltage.

The storage and cycle indicate the choice of cation and anion is a key factor to impact the battery electrochemical storage and cycle performance. As can be observed from the data, the aromatic cation combined with boron and phosphorus containing anion in this disclosure is unexpectedly and significantly better than other cation and anion combinations.

1. An electrolyte solution comprising:
a solvent;
an electrolyte salt; and
a salt represented by the following general formula I:
[HxL]^{x+}[FnA⁻]x
where:
A is boron or phosphorous, F is fluorine,
H is acidic hydrogen
L is an aprotic organic amine, n is 4 or 6,
when n=4, A is boron, and when n=6, A is phosphorous,
x is an integer from 1-3, and
at least one N atom of the aprotic organic amine is protonated by an acidic hydrogen atom,
wherein the salt is present in the electrolyte solution in an amount of between 0.1 and 5 wt. %, based on the total weight of the electrolyte solution, and
wherein the mole ratio of the salt to a Lewis acid-Lewis base complex having the formula [(FmA)x′-L] in the electrolyte solution is greater than 10,
where:
x′ is an integer from 1-3,
m is 3 or 5,
when m=3, A is boron, and when m=5, A is phosphorous.

2. The electrolyte solution of claim 1, wherein the aprotic organic amine is a neutral amine that comprises at least one nitrogen atom with a non-bonding electron pair that is available for protonation by a Bronsted acid.

3. The electrolyte solution according to claim 2, wherein the aprotic organic amine comprises a tertiary amine.

4. The electrolyte solution according to claim 2, wherein the aprotic organic amine comprises a heteroaromatic amine.

5. The electrolyte solution according to claim 1, wherein the solvent comprises an organic carbonate.

6. The electrolyte solution according to claim 5, wherein the solvent comprises ethylene carbonate, diethyl carbonate, dimethyl carbonate, ethyl methyl carbonate, vinylene carbonate, propylene carbonate, fluoroethylene carbonate, tetrahydrofuran (THF), gamma butyrolactone, sulfolane, ethyl acetate, or acetonitrile.

7. The electrolyte solution according to claim 6, wherein the solvent is present in the solution in an amount of between 15 and 98 wt. %, based on the total weight of the electrolyte solution.

8. The electrolyte solution according to claim 1, wherein the electrolyte salt comprises a lithium salt.

9. The electrolyte solution according to claim 8, wherein the electrolyte salt comprises LiPF6, LiBF4, LiClO4, lithium bis(oxalato)borate, LiN(SO2CF3)2, LiN(SO2C2F5)2, LiAsF6, LiC(SO2CF3)3, LiN(SO2F)2, LiN(SO2F)(SO2CF3), or LiN(SO2F)(SO2C4F9).

10. The electrolyte solution according to claim 8, wherein the electrolyte salt is present in the solution in an amount of between 5 and 75 wt. %, based on the total weight of the electrolyte solution.

11. An electrochemical cell comprising:
a positive electrode;
a negative electrode; and
an electrolyte solution comprising:
a solvent;
an electrolyte salt; and
a salt represented by the following general formula I:
[HxL]^{x+}[FnA⁻]x (I)
where:
A is boron or phosphorous,
F is fluorine,
H is an acidic hydrogen atom
L is an aprotic organic amine,
n is 4 or 6,
when n=4, A is boron, and when n=6, A is phosphorous,
x is an integer from 1-3, and
at least one N atom of the aprotic organic amine is protonated by an acidic hydrogen atom,
wherein prior to incorporation into the electrochemical cell, (i) the salt is present in the electrolyte solution in an amount of between 0.1 and 5 wt. %, based on the total weight of the electrolyte solution, and (ii) the mole ratio of the salt to a Lewis acid-Lewis base complex having the formula [(FmA)x′-L] in the electrolyte solution is greater than 10,
where:
x′ is an integer from 1-3
m is 3 or 5,
when m=3, A is boron, and when m=5, A is phosphorous.

12. The electrochemical cell of claim 11, wherein the aprotic organic amine is a neutral amine that comprises at least one nitrogen atom with a non-bonding electron pair that is available for protonation by a Bronsted acid.

13. The electrochemical cell according to claim 12, wherein the aprotic organic amine comprises a tertiary amine.

14. The electrochemical cell according to claim 12, wherein the aprotic organic amine comprises a heteroaromatic amine.

15. The electrochemical cell according to claim 11, wherein excess Bronsted acid or free aprotic organic amine (base) is present in the electrolyte solution at less than 5 mol % based on the stoichiometry of general formula I.

16. The electrochemical cell according to claim 11, wherein the solvent comprises an organic carbonate.

17. The electrochemical cell according to claim 16, wherein the solvent comprises ethylene carbonate, diethyl carbonate, dimethyl carbonate, ethyl methyl carbonate, vinylene carbonate, propylene carbonate, fluoroethylene carbonate, tetrahydrofuran (THF), gamma butyrolactone, sulfolane, ethyl acetate, or acetonitrile.

18. The electrochemical cell according to claim 17, wherein the solvent is present in the solution in an amount of between 15 and 98 wt. %, based on the total weight of the electrolyte solution.

19. The electrochemical cell according to claim 11, wherein the electrolyte salt comprises a lithium salt.

20. The electrochemical cell according to claim 19, wherein the electrolyte salt comprises LiPF6, LiBF4, LiClO4, lithium bis(oxalato)borate, LiN(SO2CF3)2, LiN(SO2C2F5)2, LiAsF6, LiC(SO2CF3)3, LiN(SO2F)2, LiN(SO2F)(SO2CF3), or LiN(SO2F)(SO2C4F9).

21-26. (canceled)
